(19) United States
(12) Patent Application Publication
(10) Pub. No.: US 2011/0010572 A1
(43) Pub. Date: Jan. 13, 2011

(54) NOTEBOOK COMPUTER AND POWER-SAVING METHOD THEREOF

(75) Inventor: CHENG-CHI CHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/533,012

(22) Filed: Jul. 31, 2009

(30) Foreign Application Priority Data
Jul. 7, 2009 (CN) 200910304072.4

(51) Int. Cl. G06F 1/32

(52) U.S. Cl. 713/323

(57) ABSTRACT

The infrared sensor detects whether presence of a human body within a predetermined range of a front of the notebook computer, and outputs a level signal according to the detecting result. The south bridge chip receives the level signal from the infrared sensor and outputs the level signal. The basic input/output system (BIOS) chip storages a sleep signal and a wake-up signal, and reads the level signal from the south bridge chip and selectively outputs the sleep signal or the wake-up signal according to the level signal. The memory receives the sleep signal or the wake-up signal from the BIOS chip and stores the sleep signal or the wake-up signal. The center processing unit (CPU) reads the sleep signal or the wake-up signal from the memory and controls the notebook computer to enter into a sleep state or a wake-up state.

### BACKGROUND

1. Technical Field

The present disclosure relates to notebook computers and, particularly, to a notebook computer and a power-saving method for the notebook computer.

2. Description of Related Art

Power-effective notebook computers using a power management mode to save electrical energy have been developed to save energy consumed. However, for some notebook computers using a power management mode, the feature is usually not available during regular working state when full power supply is not needed.

### BRIEF DESCRIPTION OF THE DRAWINGS

FIG. 1 is a block diagram of an embodiment of a notebook computer, the notebook computer including a basic input/output system (BIOS) chip.

FIG. 2 is a block diagram of an embodiment of the BIOS chip of FIG. 1.

FIGS. 3A and 3B are a flowchart of an embodiment of a power-saving method of a notebook computer.

### DETAILED DESCRIPTION

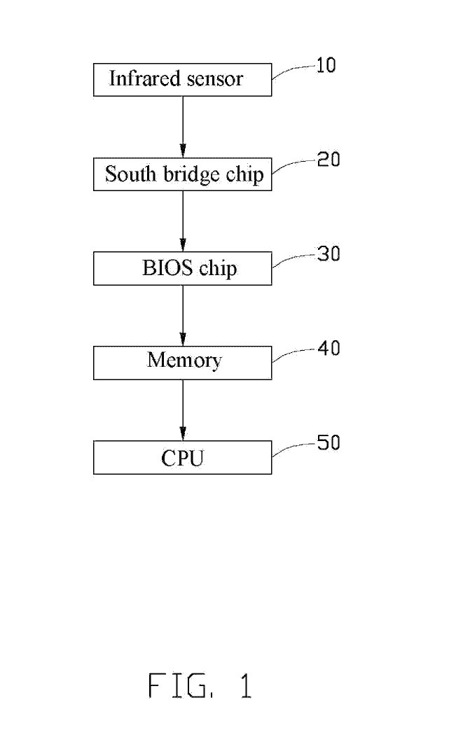

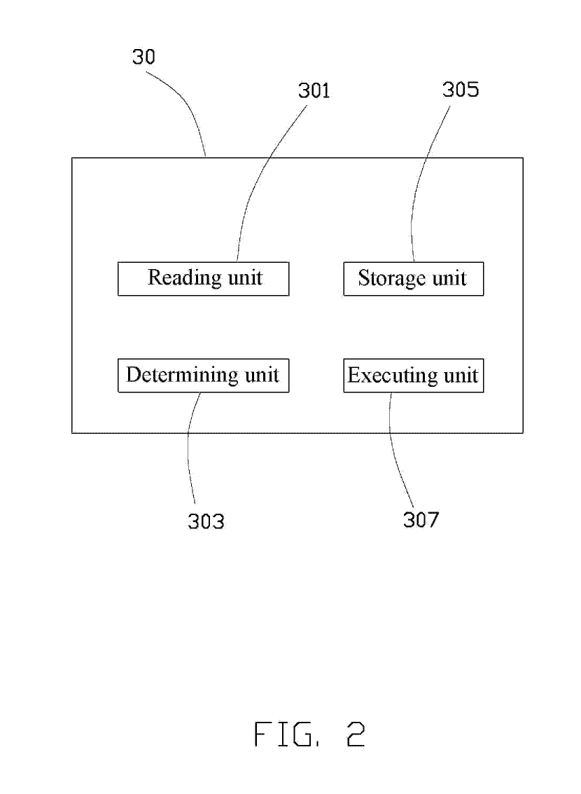

Referring to FIGS. 1 and 2, an exemplary embodiment of a notebook computer includes an infrared sensor 10, a south bridge chip 20, a basic input/output system (BIOS) chip 30, a memory 40, a center processing unit (CPU) 50, and other elements (not shown). The other elements may be known elements commonly found in computers, such as an audio card chip, a display card chip, and so on.

The infrared sensor 10 is any known infrared sensor configured for human body detection. The infrared sensor 10 is set on periphery of the notebook computer, and connected to the south bridge chip 20, for detecting presence of human body within a predetermined range of the notebook computer. In one embodiment, the predetermined range is 0.8 meters in front of the notebook computer. When a human body is detected within the predetermined range, the infrared sensor 10 outputs a high level signal to the south bridge chip 20, otherwise the infrared sensor 10 outputs a low level signal to the south bridge chip 20.

The south bridge chip 20 includes a plurality of general purpose input output (GPIO) pins. In one embodiment, an input GPIO pin of the south bridge chip 20 is configured to receive the high and low level signals from the infrared sensor 10, and an output GPIO pin of the south bridge chip 20 is configured to output the high and low level signals to the BIOS chip 30.

The BIOS chip 30 includes a reading unit 301, a determining unit 303, a storage unit 305, an executing unit 307, and others units (not shown). The others units are known units commonly found in BIOS chips, for example, a unit used for detecting memory information. The reading unit 301 is configured to receive the high and low level signals from the output GPIO pin of the south bridge chip 20. The determining unit 303 is configured to receive the high and low level signals from the reading unit 301 and determine when the signals are high and when they are low. The storage unit 305 is configured to store a sleep signal and a wake-up signal. The executing unit 307 is configured to read the sleep signal or the wak-up signal from the storage unit 305 and output the sleep signal or the wake-up signal to the memory 40.

The memory 40 is configured to store the sleep signal or the wake-up signal received from the executing unit 307 of the south bridge chip 20.

The CPU 50 is configured to read the sleep signal or the wake-up signal from the memory 40 and control the notebook computer to enter into a sleep state or a work state accordingly.

In use, when the infrared sensor 10 detects the presence of a human body within the predetermined range in front of the notebook computer, the infrared sensor 10 outputs a high level signal to the input GPIO pin of the south bridge chip 20, the reading unit 301 receives the high level signal from the output GPIO pin of the south bridge chip 20, and the notebook computer works normally. When the infrared sensor 10 does not detect the presence of a human body within range in front of the notebook computer, the infrared sensor 10 outputs a low level signal to the south bridge chip 20, the reading unit 301 receives the low level signal, and the determining unit 303 determines whether receipt of low level signals has been continuous for a predetermined time, such as 10 seconds. In other words, if no human body is present before the computer for more than 10 seconds, the executing unit 307 reads the sleep signal stored in the storage unit 305 and sends the sleep signal to the memory 40, and the CPU 50 reads the sleep signal from the memory 40 and controls the notebook computer to enter into the sleep state, otherwise the notebook computer continues to work normally.

In the sleep state, the reading unit 301 reads the level signal from the south bridge chip 20 continuously, and the determining unit 303 determines if the level signal from the reading unit 301 is a high level signal or a low level signal. When the level signal received by the determining unit 303 is a low level signal, the notebook computer keeps a sleep state. When the determining unit 303 receives a high level signal, and determines that the receipt of the high level signal has been continuous for a predetermined time, such as 10 seconds. in other words, a human body is possibly present before the computer for more than 10 seconds, the executing unit 307 reads the wake-up signal stored in the storage unit 305 and sends the wake-up signal to the memory 40, and the CPU 50 reads the wake-up signal from the memory 40 and controls the notebook computer to return to the work state, otherwise the notebook computer continues to keep sleep state.

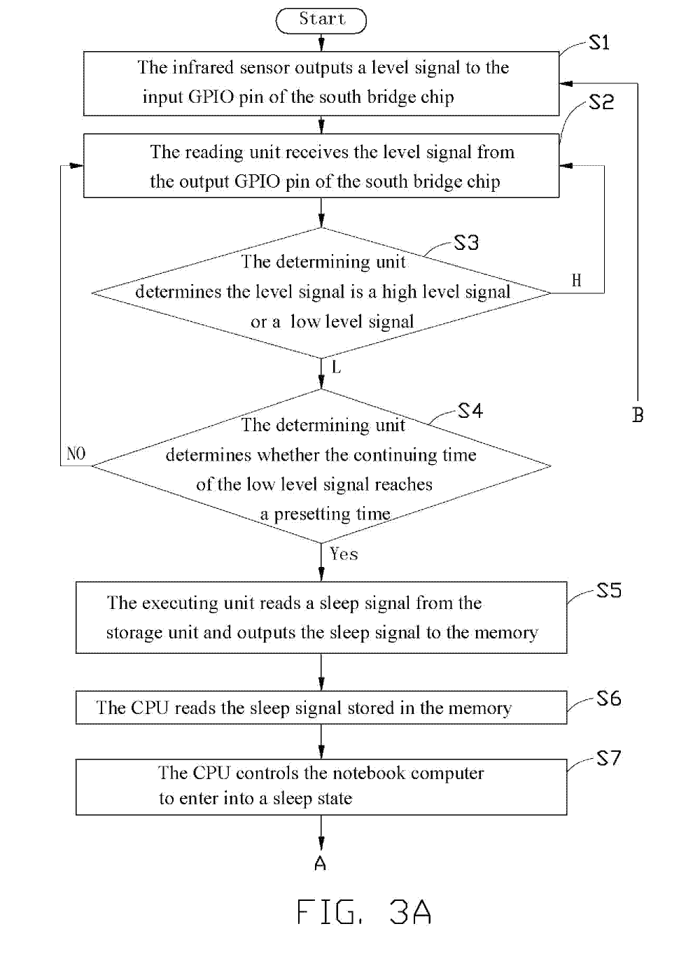

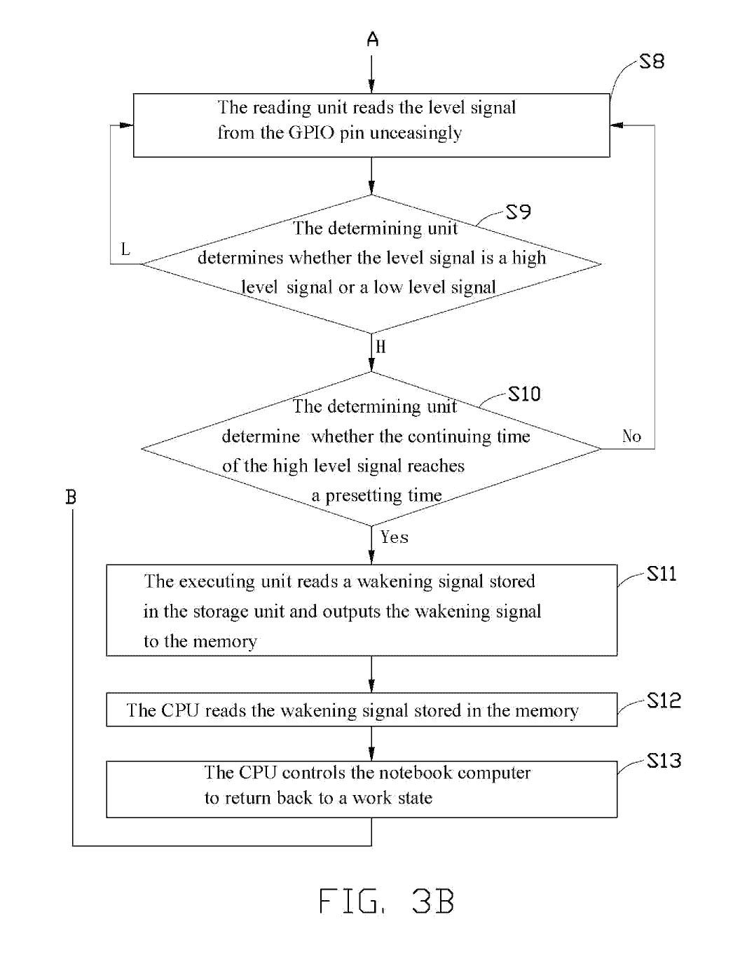

Referring to FIGS. 3A and 3B, an exemplary embodiment of a power-saving method for the above-mentioned notebook computer includes the following steps.

Step S1: the infrared sensor 10 outputs a level signal to the input GPIO pin of the south bridge chip 20.

Step S2: the reading unit 301 receives the level signal from the output GPIO pin of the south bridge chip 20.

Step S3: the determining unit 303 determines the level signal is a high level signal or a low level signal, if the level signal is a high level signal, the flow goes back to step S2, if the level signal is a low level signal, the flow goes to step S4.

Step S4: the determining unit 303 determines whether receipt of the low level signal has been continuous for a predetermined time, such as 10 seconds, if the low level signal has been continuous for a predetermined time, the flow goes to step S5, if the low level signal has not been continuous for a predetermined time, the flow goes back to step S2.

Step S5: the executing unit 307 reads a sleep signal from the storage unit 305 and outputs the sleep signal to the memory 40.

Step S6: the CPU 50 reads the sleep signal stored in the memory 40.

Step S7: the CPU 50 controls the notebook computer to enter into a sleep state, according to the sleep signal.

Step S8: the reading unit 301 receives the level signal from the GPIO pin continously.

Step S9: the determining unit 303 determines whether the level signal is a high level signal or a low level signal, if the level signal is a high level signal, the flow goes to step S10, if the level signal is a low level signal, the flow goes back to step S8.

Step S10: the determining unit 303 determines whether receipt of the high level signal has been continuous for a predetermined time, such as 10 seconds, if the high level signal has been continuous for a predetermined time, the flow goes to step S11, if the high level signal has not been continuous for a predetermined time, the flow goes back to step S8.

Step S11: the executing unit 307 reads a wake-up signal stored in the storage unit 305 and outputs the wake-up signal to the memory 40.

Step S12: the CPU 50 reads the wake-up signal stored in the memory 40.

Step S13: the CPU 50 controls the notebook computer to return back to a work state, the flow goes back to step S1.

The notebook computer can detect whether presence of a human body within a predetermined range in the front of the notebook computer via the infrared sensor 10, the BIOS chip 30 selectively outputs a sleep signal or a wake-up signal to the memory 40. The CPU 50 controls the notebook computer to enter into a sleep state or a wake-up state, according to the sleep signal or the wake-up signal read from the memory 40.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A notebook computer comprising:
an infrared sensor to detect presence of a human body within a predetermined range of the notebook computer, and output a level signal according to the detecting result;
a south bridge chip to receive the level signal from the infrared sensor, and output the level signal;
a basic input/output system (BIOS) chip storing a sleep signal and a wake-up signal, wherein the BIOS chip is operable to read the level signal from the south bridge chip and selectively output the sleep signal or the wake-up signal according to the level signal;
a memory to receive the sleep signal or the wake-up signal from the BIOS chip and store the sleep signal or the wake-up signal; and
a central processing unit (CPU) to read the sleep signal or the wake-up signal from the memory, and control the notebook computer to enter into a sleep state or a wake-up state.

2. The notebook computer of claim 1, wherein the infrared sensor outputs a high level signal to the south bridge chip in response to a human body within the predetermined range in front of the notebook computer, the BIOS chip receives the high level signal and outputs the wake-up signal to the memory according to the high level signal; and wherein the infrared sensor outputs a low level signal to the south bridge chip in response to no human body within the predetermined range in front of the notebook computer, the BIOS chip receives the low level signal and outputs a sleep signal to the memory according to the low level signal.

3. The notebook computer of claim 2, wherein the BIOS chip comprises:
a reading unit to receive the level signal from the south bridge chip;
a storage unit to store the sleep signal and the wake-up signal;
a determining unit to receive the level signal from the reading unit and determine whether the level signal received is a high level signal or a low level signal; and
an executing unit to read the sleep signal or the wake-up signal from the storage unit and output the sleep signal or the wake-up signal to the memory according to the determination by the determining unit;
wherein when the determining unit receives a high level signal, the executing unit reads the wake-up signal stored in the storage unit and sends the wake-up signal to the memory, when the determining unit receives a low level signal, the executing unit reads the sleep signal stored in the storage unit and sends the sleep signal to the memory.

4. The notebook computer of claim 3, wherein the determining unit determines whether receipt of the high level signal or the low level signal has been continuous for a predetermined time, upon condition that the high level signal or the low level signal has been continuous for a predetermined time, the executing unit reads the wake-up signal or the sleep signal stored in the storage unit accordingly and sends the wake-up signal or the sleep signal to the memory.

5. The notebook computer of claim 1, wherein the infrared sensor is set on periphery of the notebook computer, and the predetermined range of the notebook computer is 0.8 meters.

6. A power-saving method for a notebook computer, the power-saving method comprising:
detecting whether a human body is present within a predetermined range of the notebook computer via an infrared sensor, and outputting a level signal to a south bridge chip based on the presence or non-presence of a human body;
outputting a sleep signal or a wake-up signal to a memory from a basic input/output system (BIOS) chip, according to the level signal outputted from the south bridge chip; and
reading the sleep signal or the wake-up signal stored in the memory according the level signal and controlling the notebook computer to enter into a sleep state or a wake-up state.

7. The power-saving method of claim 6, the step of outputting a level signal comprises:
the infrared sensor outputting a high level signal to the south bridge chip in response to a human body within the predetermined range in front of the notebook computer; and
the infrared sensor outputting a low level signal to the south bridge chip in response to no human body within the predetermined range in front of the notebook computer.

8. The power-saving method of claim 7, wherein the step of outputting a sleep signal or a wake-up signal comprises:
upon condition that the level signal is a high level signal, sending the wake-up signal to the memory, upon condition that the level signal is low level signal, sending the sleep signal to the memory.

9. The power-saving method of claim 8, further comprising:
determining whether receipt of the high level signal has been continuous for a predetermined time, upon condition that the high level signal has been continuous for a predetermined time, sending the wake-up signal to the memory; upon condition that the high level signal has not been continuous for a predetermined time, receiving the level signal from the south bridge chip continuously.

10. The power-saving method of claim 8, further comprising:
determining whether receipt of the low level signal has been continuous for a predetermined time, upon condition that the low level signal has been continuous for a predetermined time, sending the sleep signal to the memory; upon condition that the low level signal has not been continuous for a predetermined time, receiving the level signal from the south bridge chip continuously.
